(19) United States
(12) Patent Application Publication
(10) Pub. No.: US 2010/0012440 A1
(43) Pub. Date: Jan. 21, 2010

(54) Hydraulic Disk Brake Retractor System And Method Of Retracting

(76) Inventor: Thomas H. Vu, Cedar Falls, IA (US)

Correspondence Address: DEERE & COMPANY, ONE JOHN DEERE PLACE, MOLINE, IL, 61265, US

(21) Appl. No.: 12/173,129

(22) Filed: Jul. 15, 2008

(51) Int. Cl. F16D 55/22

(52) U.S. Cl. 188/72.3

(57) ABSTRACT

The invention relates generally to a disk brake system for a hydraulic disk brake retractor system that maximizes running clearance while still effectively providing for manual braking in a power-down condition. The invention uses a simple spring-loaded brake retractor system comprised of a brake piston, a brake spring, and a retractor shaft.

### FIELD OF THE INVENTION

The present invention relates generally to a disk brake system in a moving vehicle. More specifically, it relates to a hydraulic disk brake retractor system.

### BACKGROUND OF THE INVENTION

Brake assemblies are generally used to stop the movement of motor vehicles, such as an agricultural tractor. As shown in U.S. Pat. No. 6,002,976, the driveline of a typical agricultural tractor, for example a tractor in the John Deere 6000 series, includes an engine, a shifted multi-speed transmission, a reversing unit, a drive clutch, an optional creeper transmission, a shifted range transmission, and a rear axle differential gear which drives the rear wheels. As shown in U.S. Pat. No. 5,197,574, a brake may also be provided between the transmission housing and the rear axle differential gear. Due to low operating speeds, large mass and high torque under which agricultural tractors operate, these brakes are often configured so the brake disks are submerged in oil. The oil serves to lubricate and carry heat away from the brake disks when the brakes are applied by a tractor operator.

When the brakes are initially assembled, an optimal running clearance is set between a brake piston, the brake disks, separator plates (if applicable) and a brake cover. Ideally, a very small running clearance between brake disks is desired to allow for fast brake engagement and a short pedal throw. However, if the clearance is too small, windage effect may prevent sufficient oil flow between the braking surfaces, interfering with the lubrication and cooling of the brake disks. In addition, the small amount of oil between the braking surfaces may become entrapped. As a result, even when the brake is not engaged, significant heat may be generated between the braking surfaces and the entrapped oil, causing damage to the brake assembly.

In most of today's brake system design, there is usually a compromise between having as much running clearance as possible to reduce drag, and improve system efficiency, while at the same time, keeping this running clearance small to meet manual braking stopping distance versus time requirement per regulation.

To minimize windage loss through brake disks, it is therefore desirable to maximize the running clearance between brake disks. Alternatively, it is also desirable to minimize running clearance between brake disks in order to maximize braking performance, especially in the power-down condition, where hydraulic power to brake valve is lost, and the operator must make an emergency brake stop with only the limited available flow volume from the brake valve.

For the reasons listed above, it has been a challenge for the industry to provide a brake design with more running clearance for improved efficiency, and yet, still be able to meet the regulated requirement for manual brake stopping distance versus time.

### SUMMARY OF THE INVENTION

In light of the above background information, an improved spring-loaded brake retractor system is proposed. This spring-loaded brake retractor system uses the system's hydraulic power to retract the brake piston to provide desired running clearance between disks. In the power-down condition, the spring will provide the force to position the brake piston against brake disk pack to eliminate the piston “travel” that is normally required to bring brake piston and brake disks to a near contact position.

The proposed invention improves brake system efficiency by allowing increased running clearance between brake disks. Additionally, the invention minimizes the distance the piston has to travel, and the corresponding volume of oil required from brake valve, to engage the brake in power-down condition.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a cross-section view of a brake assembly with a brake retractor system according to an embodiment of the present invention.

FIG. 2 is a cross-section view of a brake assembly with a brake retractor system in an embodiment of the present invention engaging a pair of friction disks and moving axially to eliminate running clearance.

FIG. 3 is a cross-section view of a brake assembly with a brake retractor system in an embodiment of the present invention fully engaging a pair of friction disks and eliminating running clearance.

FIG. 4 is an expanded view of the brake retractor system according to an embodiment of the present invention.

### DESCRIPTION OF THE PREFERRED EMBODIMENT

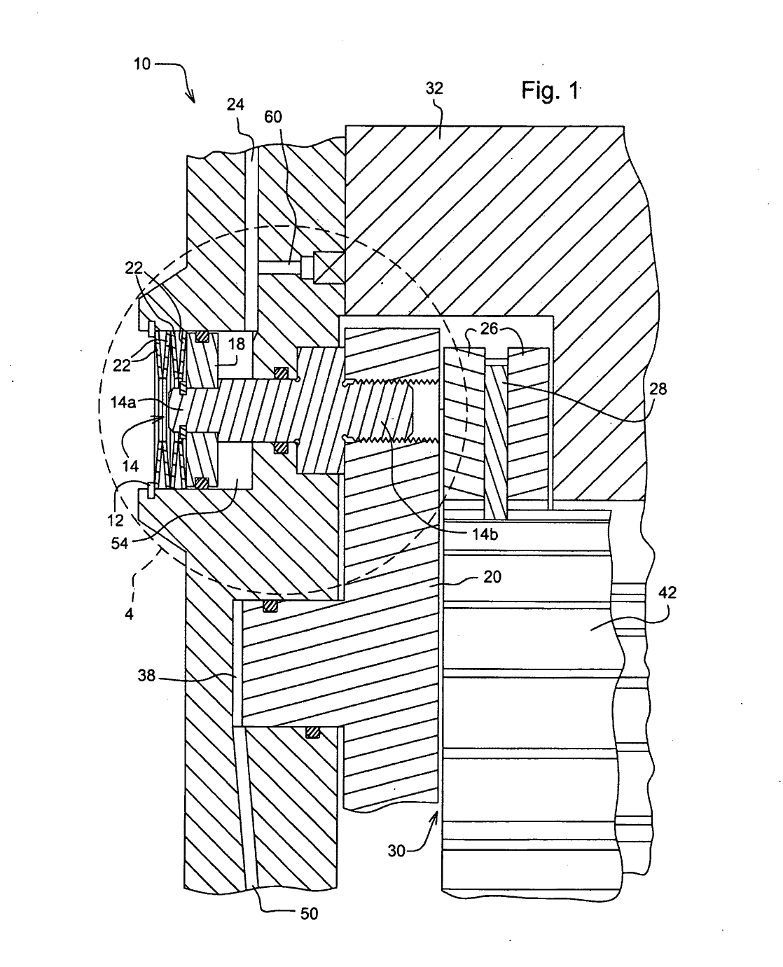

In general, the present invention is directed to a spring-loaded brake retractor system 36, FIGS. 1-4, comprising a retractor shaft 14, brake spring 22 and retractor piston 18.

Reference is made to FIG. 1, which shows a brake assembly designated at 10, generally embodying the principles of the present invention. As its primary components, the brake assembly 10 includes a retractor shaft 14 mounted inside a brake housing cavity 32, having a first end 14a and a second end 14b; a retractor piston 18 attached to the first end of retractor shaft 14a; a brake piston 20 attached to the second end of the retractor shaft 14b that prevents the brake piston 20 from rotating, and to facilitate the axial movement of the brake piston 20 during the engaged or disengaged modes; a retractor piston 18 adjacently located next to a brake spring 22, which utilizes a source of hydraulic pressure or fluid flowing through a passage 24 to disengage the brake and retract the brake piston 20 in a second direction opposite the first; a brake spring 22 situated between a retaining device such as a snap ring 12 that enables a retractor piston 18 and retractor shaft 14 to move in a first direction to engage the brake piston 20. At least one separator plate 28 is fixedly splined onto a rotating hub 42. Also fixedly splined into a stationary brake housing cavity 32 is at least a first and second friction disk 26 for engaging separator disk 28 that is splined onto hub 42 that rotates within brake housing cavity 32. With at least a first and second friction disk 26 separator plate 28 fits in between the at least first and second friction disks 26 to hold them together.

As shown in FIG. 1, during normal tractor operation, brake (not shown) is deenergized, oil pressure in annular passage 38 is zero and hydraulic pressure is supplied to retractor piston cavity 54 through passage 24. This hydraulic pressure in cavity 54 acts to move retractor piston 18 against spring 22, the movement of the retractor piston 18 also moves the retractor shaft 14, and the brake piston 20 in the second direction within the brake housing cavity 32. Under this condition, the brake piston 20 is disengaged, and the running clearance 30 is created and or realized.

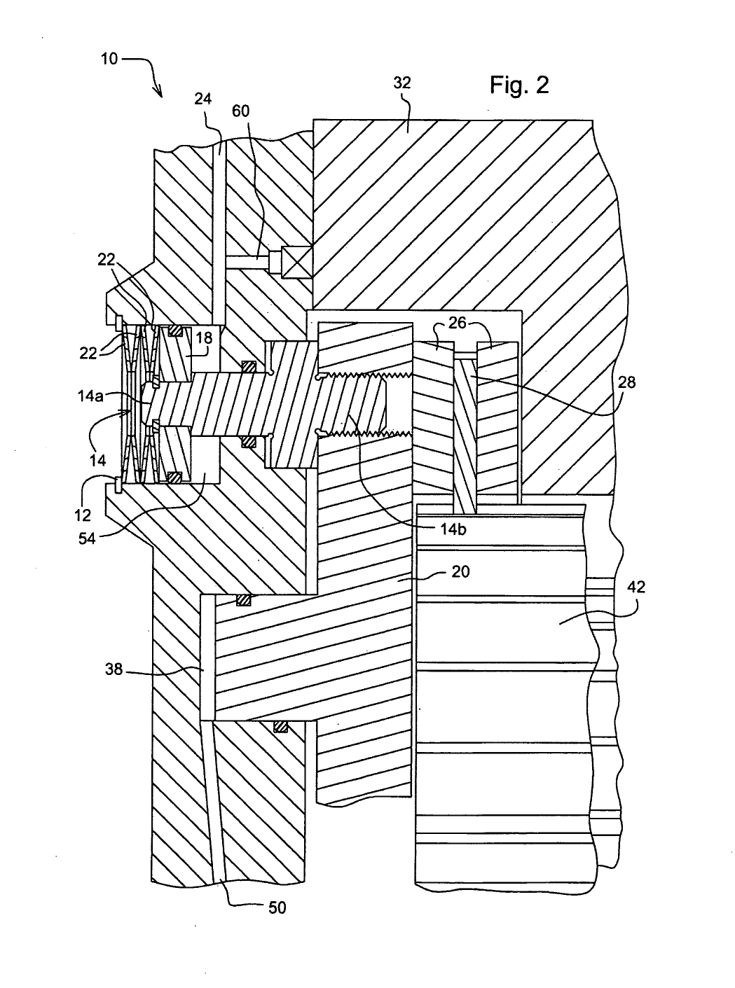

As shown in FIG. 2, during normal braking, brake valve (not shown) is energized, which sends pressured oil to brake piston annular passage 38 via passage 50, this pressurized oil moves the brake piston 20 within the brake housing cavity 32, closing the running clearances 30 on each side of the at least first and second friction disks 26 and resulting in frictional engagement of the at least first and second rotating friction disks 26 between brake piston 20 and brake housing cavity 32.

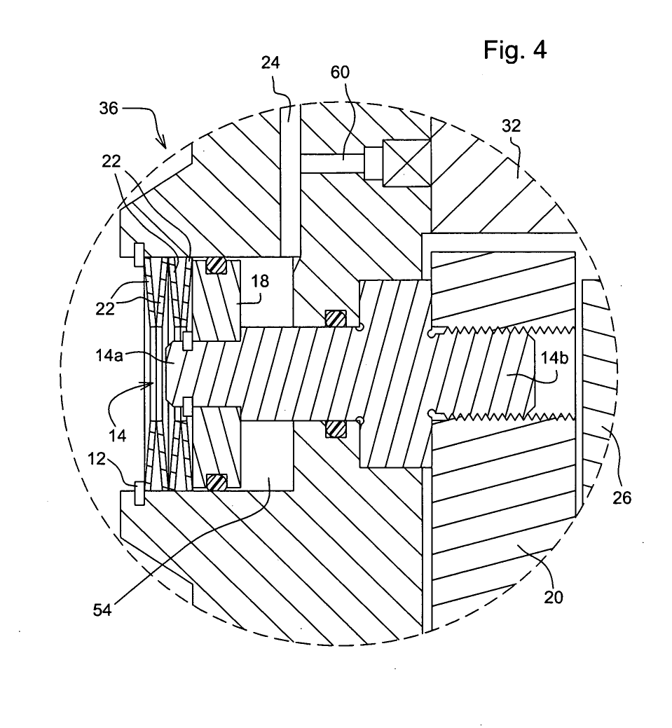

When brake is deenergized, as shown in FIGS. 1 and 4, the source of hydraulic pressure or oil pressure in annular passage 38 is vented, and the retractor system 36 returns the brake piston 20 in a second direction opposite the first to its initial position, disengaging brake piston 20 from the at least first and second friction disks 26.

The actual running clearance of the brake assembly 10 equals the distance the brake piston 20 must travel in order to clamp the at least first and second friction disks 26 equal to the sum of the running clearances 30. The desired running clearance is based on various factors including at least a first and second friction disk 26, separator plates 28, the required response time of the brake assembly 10, the brake retractor system 36 and the cooling requirements for a particular application. In addition, windage effects may generate additional heat and prevent sufficient hydraulic pressure from flowing between the at least first and second friction disks 26. These factors may cause damage to brake assembly 10 having very small running clearance 30. Thus, running clearance 30 utilizing a brake retractor system 36 eliminates the risk of the damage, while still keeping the response time and pedal throw to a minimum.

The invention is carried out when the system 36 is in a power on condition, pressurized hydraulic pressure or fluid in a passage 24 to cavity 54 is used to retract the brake piston 20 in a second direction opposite the first, and apply a disengagement force against a brake spring 22. This retraction then provides a desired running clearance 30 between disks 26 and separator plate 28, FIGS. 1 and 4.

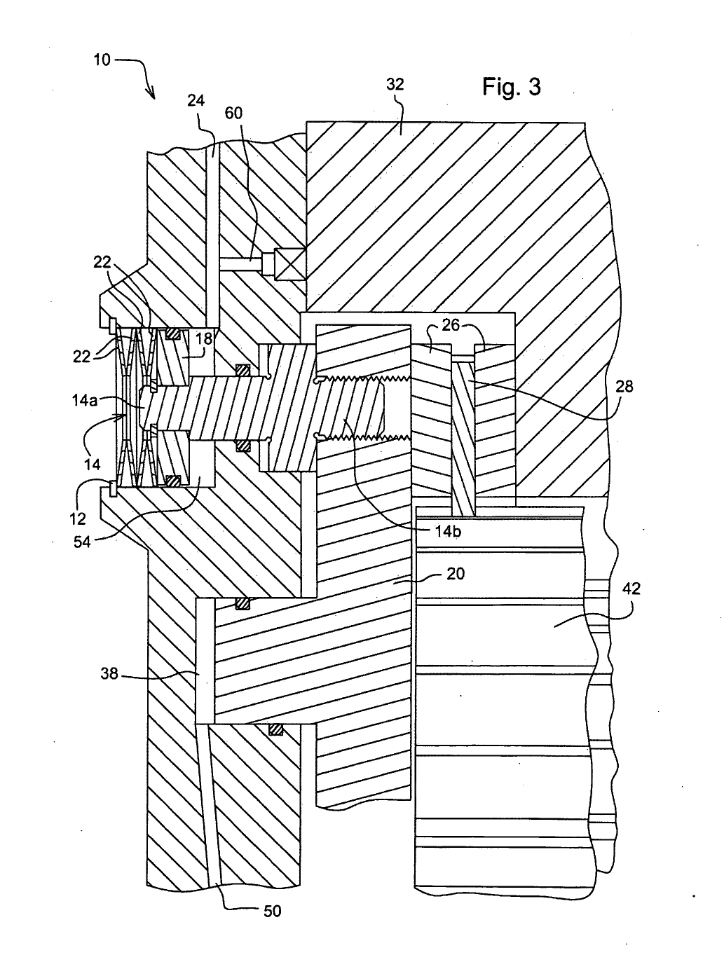

In the power down condition, as shown in FIG. 3, with system hydraulic pressure in passage 24, to cavity 54 being zero, the brake spring 22 will provide proper force in a first direction to position brake piston 20 against the at least first and second friction disks 26 to minimize the piston travel and bring brake piston 20 to a point called the kiss-up position. Due to the size of brake spring 22, brake spring 22 will only close the clearance gap 30 up to the kiss-up position. To reach full engagement, it is necessary for the operator to push the brake pedal to come to an immediate stop. The kiss-up position may also be referred to as a near contact position and essentially means there is not enough torque capacity in a power-down condition to completely engage the brake therefore less than full brake engagement occurs. Less that full engagement may also be considered as the point just prior to full engagement. Additionally, in the power down condition, the source of hydraulic pressure or fluid to the brake valve (not shown) is lost and limited flow volume from the brake valve exists therefore making it difficult to stop the vehicle. To accommodate this problem and reach full brake engagement, the brake pedal is pushed by operator to eliminate the remaining running clearance. If the running clearance 30 is eliminated, the flow volume of hydraulic pressure or fluid in passage 24 from the brake valve during an emergency stop will move the brake piston 20 to fully engage the at least first and second friction disks 26.

This invention is being shown and claimed with one brake retractor. However, a preferred alternative embodiment can be designed to accommodate three brake retractors. The three brake retractors are positioned on the outer edge of the brake piston. By locating the brake retractors on the outer edge of the brake piston, the entire system has a tendency to be more balanced than a system that positions its brake retractors near the center of axis of the brake piston. Passage 60 is used to supply oil pressure to all three brake retractors. Additionally, the further away each brake retractor is from the center of axis of the brake piston the more torque carrying capacity.

As the person skilled in the art will readily appreciate, the above description is meant as an illustration of implementation of the principles of this invention. This description is not intended to limit the scope or application of this invention in that the invention is susceptible to modification, variation and change, without departing from spirit of this invention, as defined in the following claims.

1. A hydraulic disk brake retractor system for engaging and disengaging a brake and brake assembly on a moving vehicle during a power-on and power-down condition, comprising:
at least one friction disk splined into a brake housing cavity, the at least one friction disk is engaged by a brake piston and rotates within the brake housing cavity;
at least one separator plate splined onto a rotating hub within the brake housing cavity, the at least one separator plate is engaged by the at least one friction disk;
a source of hydraulic fluid flowing within a narrow passage in the brake housing cavity for disengaging the brake and retracting the brake piston;
a retractor shaft mounted inside the brake housing cavity, having a first end and a second end, a retractor piston attached to the first end of the retractor shaft, the brake piston attached to the second end of the retractor shaft;
the retractor piston adjacently located next to a brake spring, the brake spring situated between a retaining device and the retractor piston which engages the brake piston.

2. The hydraulic disk brake retractor system of claim 1 wherein the brake spring is biased to urge the brake piston to a near contact position for brake engagement.

3. The hydraulic disk brake retractor system of claim 1 wherein the brake piston is urged to a near contact position during the power-down condition.

4. The hydraulic disk brake retractor system of claim 3 wherein the brake is not fully engaged during the power-down condition.

5. The hydraulic disk brake retractor system of claim 1 wherein the retractor shaft facilitates an axial movement of the brake piston during an engaged mode and a disengaged mode.

6. The hydraulic disk brake retractor system of claim 5 wherein the retractor shaft engages the brake piston to cause axial movement.

7. The hydraulic disk brake retractor system of claim 1 further comprising a brake valve wherein the source of hydraulic fluid within a brake valve is zero during a power-down condition.

8. The hydraulic disk brake retractor system of claim 1 wherein the source of hydraulic fluid provides a force to the retractor piston and retractor shaft.

9. The hydraulic disk brake retractor system of claim 8 wherein the retractor shaft applies the force to the brake piston.

10. A method of retracting a brake piston using a hydraulic disk brake retractor system for engaging a brake on a moving vehicle during a power-down condition, comprising:
activating the brake retractor system in the power-down condition;
using a source of hydraulic pressure in the power-down condition to apply an engagement force to a brake spring;
applying the brake spring engagement force to a retractor shaft;
moving the retractor shaft in a first direction to engage a brake piston;
pushing the brake piston into a near contact position with a first friction disk and the brake piston and between a second friction disk and a brake housing cavity;
closing a running clearance between the first friction disk and the brake piston and between the second friction disk and the brake housing cavity;

11. The method of claim 10 wherein the brake spring moves the retractor shaft and the brake piston into a near contact position with the first and second friction disks.

12. The method of claim 10 wherein the near contact position is less than full brake engagement.

13. The method of claim 10 wherein an operator pushes a brake pedal to open a brake valve to release the source of hydraulic pressure.

14. The method of claim 13 wherein as the source of hydraulic pressure is released the brake piston reaches full brake engagement.

15. The method of claim 10 wherein the running clearance is eliminated if full brake engagement is reached.

16. A method of retracting a brake piston by initially engaging a brake piston in a first direction opposite an original start position, using a hydraulic disk brake retractor system during a power-on condition to disengage a brake on a moving vehicle and retracting the brake piston to the original start position, comprising;
applying a source of hydraulic pressure in the power-on condition to disengage the brake;
using the source of hydraulic pressure in the power-on condition to apply a disengagement force against a brake spring;
retracting the brake piston in a second direction after the disengagement force is applied;
increasing a running clearance between at least two friction disks during a brake piston retraction;
returning the hydraulic disk brake retractor system and the brake piston to the original start position.

17. The method of claim 16 wherein the source of hydraulic pressure is used to retract the brake piston and disengage brake in the power-on condition.

18. The method of claim 17 wherein the source of hydraulic pressure is depressurized in the power-on condition.

19. The method of claim 16 wherein the hydraulic brake retractor system is retracted to the original start position until a desired running clearance is provided.
